(19) United States
(12) Patent Application Publication
(10) Pub. No.: US 2008/0068300 A1
(43) Pub. Date: Mar. 20, 2008

(54) Plasma Display Device

(76) Inventors: Hiroki Ikeda, Kawasaki (JP); Toshio Ueda, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/735,631

(22) Filed: Apr. 16, 2007

(30) Foreign Application Priority Data
Sep. 20, 2006 (JP) 2006-254846

(51) Int. Cl. G09G 3/28

(52) U.S. Cl. 345/60

(57) ABSTRACT

There is provided a plasma display device including: a plasma display panel having a plurality of address electrodes selecting a display cell to emit light; a data generation circuit generating and outputting a plurality of address data for an application of a voltage to the plurality of address electrodes; a plurality of output ports outputting the plurality of address data; a selector switching over connections of outputs of the plurality of address data generated by the data generation circuit and the plurality of output ports.

### CROSS-REFERENCE TO RELATED APPLICATIONS

This application is based upon and claims the benefit of priority from the prior Japanese Patent Application No. 2006-254846, filed on Sep. 20, 2006, the entire contents of which are incorporated herein by reference.

### BACKGROUND OF THE INVENTION

1. Field of the Invention

The present invention relates to a plasma display device.

2. Description of the Related Art

In following Patent Document 1, there is described a flat display panel in which vertical display electrodes formed on a glass substrate are gathered per each connection area and lead-out portions are provided in a lower edge side.

In following Patent Document 2, it is described that in a panel main body having numerous discharge cells, a terminal lead-out portion of address electrodes and a print wiring board mounting a drive circuit of an address driver circuit are connected in both sides of upper and lower end portions of the panel main body, due to a structure of a plasma display device.

[Patent Document 1] Japanese Patent Application Laid-open No. 2001-283736

[Patent Document 2] Japanese Patent Application Laid-open No. 2005-340131

With a plasma display panel being highly fine, a number of address electrodes increases. Consequently, an interval of the address electrodes becomes short, and a defect due to a short circuit or a break of the address electrode is easy to occur.

### SUMMARY OF THE INVENTION

A purpose of the present invention is to provide a plasma display device including a control circuit which can be used for a plurality of systems to lead out an address electrode from a plasma display panel.

A plasma display device of the present invention includes: a plasma display panel having a plurality of address electrodes selecting a display cell to emit light; a data generation circuit generating and outputting a plurality of address data for an application of a voltage to the plurality of address electrodes; a plurality of output ports outputting the plurality of address data; and a selector switching over connections of the outputs of the plurality of address data generated by the data generation circuit and the plurality of output ports.

A plasma display device of the present invention includes: a plasma display panel having a plurality of address electrodes selecting a display cell to emit light; a data generation circuit generating and outputting a plurality of address data for an application of a voltage to the plurality of address electrodes; and a plurality of output ports outputting the plurality of address data, wherein the data generation circuit generates the address data by rearranging display data on one line in correspondence with a system of leading out the address electrodes from the plasma display panel to an address electrode drive circuit.

### BRIEF DESCRIPTION OF THE DRAWINGS

FIG. 1 is a diagram showing a configuration example of a plasma display device according to an embodiment of the present invention;

FIG. 2 is an exploded perspective view showing a structure example of a plasma display panel;

FIG. 3 is a diagram showing a configuration of one frame of an image;

FIG. 4 is a timing chart showing an operation example of a reset period, an address period, and a sustain period;

FIG. 5 is a view showing a first address electrode system;

FIG. 6 is an enlarged view of a lead-out portion of FIG. 5;

FIG. 7 is a view showing a second address electrode system;

FIG. 8 is an enlarged view of a lead-out portion in a lower end portion of a plasma display panel of FIG. 7;

FIG. 9 is a view showing a third address electrode system;

FIG. 10 is an enlarged view of a lead-out portion in a lower end portion of a plasma display panel of FIG. 9;

FIG. 11 is a view showing another third address electrode system;

FIG. 12 is a diagram showing a configuration example of a control circuit and an address driver module of the first address electrode system;

FIG. 13 is a diagram showing a configuration example of a control circuit and an address driver module of the third address electrode system;

FIG. 14 is a diagram showing a configuration example of a control circuit and an address driver module of the second address electrode system;

FIG. 15 is a diagram showing a configuration example of the control circuit and the address driver module of the third address electrode system;

FIG. 16 is a diagram showing a configuration example of the control circuit and the address driver module of the second address electrode system;

FIG. 17 is a diagram showing a configuration example of the control circuit of FIG. 15 and FIG. 16;

FIG. 18 is a diagram showing sub-frame data which a frame memory write circuit writes to a frame memory in the third address electrode system;

FIG. 19 is a diagram showing sub-frame data which a frame memory write circuit writes to a frame memory in the second address electrode system;

FIG. 20 is a diagram showing a configuration example of an address data output control circuit of FIG. 17; and

FIG. 21 is a diagram showing a configuration example of a line selector of FIG. 20.

### DETAILED DESCRIPTION OF THE PREFERRED EMBODIMENTS

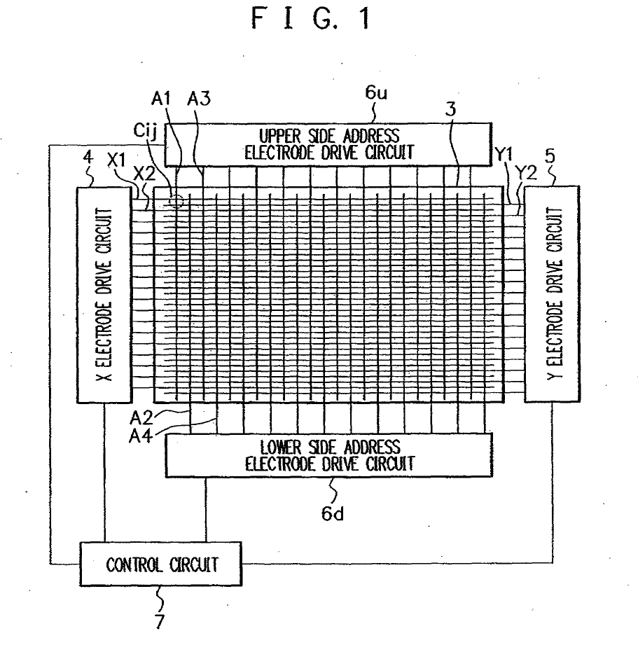

FIG. 1 is a diagram showing a configuration example of a plasma display device according to an embodiment of the present invention. A control circuit 7 controls an X electrode drive circuit 4, a Y electrode drive circuit 5, an upper side address electrode drive circuit 6u, and a lower side address electrode drive circuit 6d. The X electrode drive circuit 4 supplies a predetermined voltage to a plurality of X electrodes X1, X2, and so on. Hereinafter, the X electrodes X1, X2, and so on are individually or collectively referred to as an X electrode Xi, “i” meaning a subscript. The Y electrode drive circuit 5 supplies a predetermined voltage to a plurality of Y (scan) electrodes Y1, Y2, and so on. Hereinafter, the Y electrodes Y1, Y2, and so on are individually or collectively referred to as a Y electrode Yi, “i” meaning a subscript. The upper side address electrode drive circuit 6u supplies a predetermined voltage to odd numberth address electrodes A1, A3, A5, and so on from an upper side of a plasma display panel 3. The lower side address electrode drive circuit 6d supplies a predetermined voltage to even numberth address electrodes A2, A4, A6, and so on from a lower side of the plasma display panel 3. Hereinafter, the address electrodes A1, A2, A3, and so on are individually or collectively referred to as an address electrode Aj, “j” meaning a subscript.

In the plasma display panel 3, the Y electrode Yi and the X electrode Xi form rows extending in parallel in a horizontal direction, while the address electrode Aj forms a column extending in a vertical direction. The Y electrode Yi and the X electrode Xi are arranged alternately in the vertical direction. The Y electrode Yi and the address electrode Aj form a two-dimensional matrix with i rows and j rows. A display cell Cij is formed of an intersection of the Y electrode Yi and the address electrode Aj and the X electrode Xi correspondingly adjacent thereto. This display cell Cij corresponds to a pixel, and the plasma display panel 3 can display a two-dimensional image.

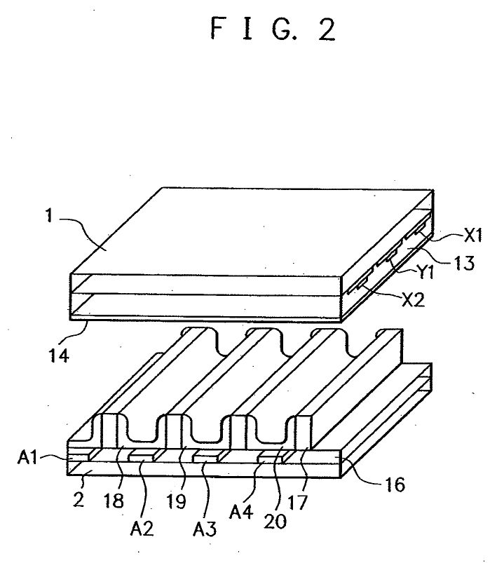

FIG. 2 is an exploded perspective view showing a structure example of the plasma display panel 3. The X electrode Xi and the Y electrode Yi are formed on a front glass substrate 1. Thereon is deposited a dielectric layer 13 for insulation from a discharge space. Further thereon is deposited an MgO (magnesium oxide) protective layer 14. Meanwhile, the address electrode Aj is formed on a rear glass substrate 2 arranged opposed to the front glass substrate 1. Thereon a dielectric layer 16 is deposited. Further thereon phosphors 18 to 20 are deposited. On an inside surface of a partition wall 17, the phosphors 18 to 20 in red, blue and green are arranged and applied in stripes for each color. A discharge between the X electrode Xi and the Y electrode Yi excites the phosphors 18 to 20 to emit light in each color. In the discharge space between the front glass substrate 1 and the rear glass substrate 2, a Ne+Xe Penning gas or the like is filled.

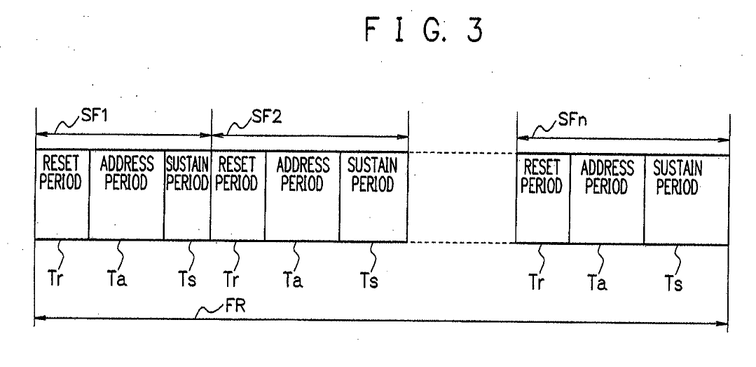

FIG. 3 is a diagram showing a configuration example of one frame FR of an image. The image is formed of sixty frames per second, for example. The one frame FR is formed of a first sub-frame SF1, a second sub-frame SF2, . . . and an n-th sub-frame SFn. The “n” is “10” for example and is equivalent to a number of tone bits. The sub-frames SF1, SF2 and so on are hereinafter individually or collectively referred to as a sub-frame SF. Each sub-frame SF is constituted with a reset period Tr, an address period Ta and a sustain (sustain discharge) period Ts.

FIG. 4 is a timing chart showing an operation example of the reset period Tr, the address period Ta and the sustain period Ts. During the reset period Tr, the display cell Cij is initialized by applying a predetermined voltage to the X electrode Xi and the Y electrode Yi.

During the address period Ta, scan pulses are sequentially scanned and applied to the Y electrodes Y1, Y2, and so on, and in correspondence with the scan pulse, an address pulse is applied to the address electrode Aj, whereby a display pixel is selected. If the address pulse of the address electrode Aj is generated in correspondence with the scan pulse of the Y electrode Yi, the display cell of that Y electrode Yi and the X electrode Xi is selected. If the address pulse of the address electrode Aj is not generated in correspondence with the scan pulse of the Y electrode Yi, the display cell of that Y electrode Yi and the X electrode Xi is not selected. When the address pulse is generated in correspondence with the scan pulse, an address discharge between the address electrode Aj and the Y electrode Yi occurs, and with that address discharge being a pilot, a discharge occurs between the X electrode Xi and the Y electrode Yi, so that a negative electric charge is accumulated in the X electrode Xi and a positive electric charge is accumulated in the Y electrode Yi.

During the sustain period Ts, sustain pulses reverse to each other are applied to between the X electrode Xi and the Y electrode Yi, so that a sustain discharge is performed between the X electrode Xi and the Y electrode Yi of the selected display cell to emit light. Numbers of light emissions (length of the sustain period Ts) by the sustain pulses between the X electrode Xi and the Y electrode Yi are different among respective sub-frames SF. Hereby, a tone value can be determined.

FIG. 5 is a view showing a first address electrode system. The first address electrode system is a system in which address electrodes Aj are led out from a lower side of a plasma display panel 3. In this case, in FIG. 1, the lower side address electrode drive circuit 6d supplies the voltage to all the address electrodes A1, A2, A3, and so on, and the upper side address electrode drive circuit 6u is omitted. In a lower end portion of the plasma display panel 3, there are provided fifteen lead-out portions 501 of a plurality of the address electrodes Aj. The fifteen lead-out portions 501 are connected to fifteen address driver modules D1 to D15. One address driver module is connected to one lead-out portion 501. The address driver modules D1 to D15 correspond to the lower side address electrode drive circuit 6d of FIG. 1.

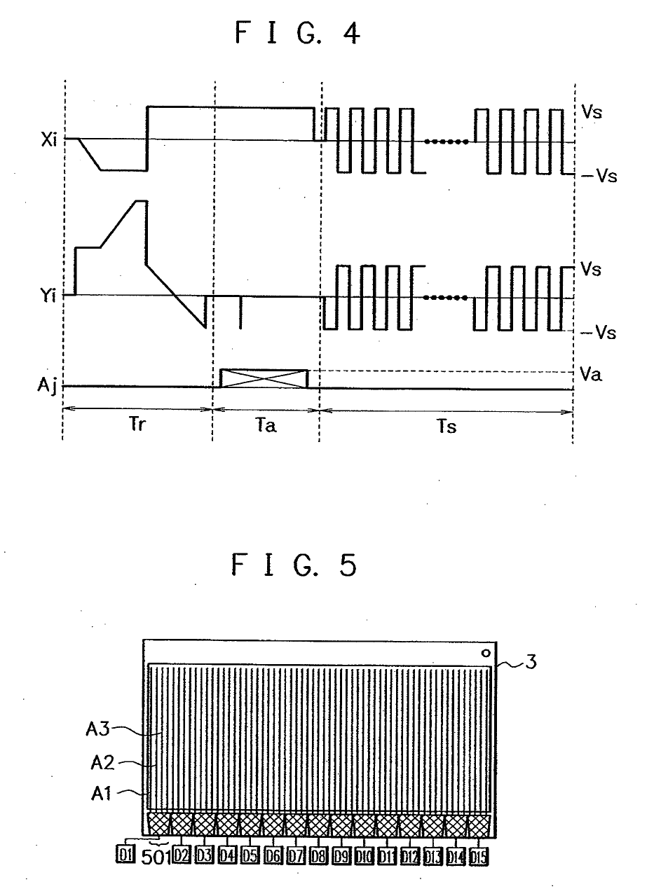

FIG. 6 is an enlarged view of the lead-out portion 501 of FIG. 5. Since the lead-out portion 501 is connected to the address driver module D1 or the like, an interval of the address electrodes Aj in the lead-out portion 501 is shorter than an interval of the address electrodes Aj in the plasma display panel 3.

Recently, the plasma display device is becoming highly fine. As a result, the interval of the address electrodes Aj of the plasma display panel is becoming short. When the interval of the address electrodes Aj becomes short due to high fineness, a short circuit or a break of the address electrode Aj becomes easy to occur in the lead-out portion 501. Thus, as shown in FIG. 1, the upper side address electrode drive circuit 6u supplies the voltage to the odd numberth address electrodes A1, A3, A5 and so on, while the lower side address electrode drive circuit 6d supplies the voltage to the even numberth address electrodes A2, A4, A6, and so on.

FIG. 7 is a view showing a second address electrode system. The second address electrode system, corresponding to the plasma display panel 3 of FIG. 1, is a system in which address electrodes Aj are led out from an upper side and a lower side of a plasma display panel 3.

In a lower end portion of the plasma display panel 3, there are provided eight lead-out portions 701 for even numberth address electrodes A2, A4, A6 and so on. The eight lead-out portions 701 are connected to address driver modules D1 to D8. One address driver module is connected to one lead-out portion 701. The address driver modules D1 to D8 correspond to the lower side address electrode drive circuit 6d of FIG. 1.

In an upper end portion of the plasma display panel 3, there are provided eight lead-out portions 701 of the odd numberth address electrodes A1, A3, A5 and so on. The eight lead-out portions 701 are connected to address driver modules U1 to U8. One address driver module is connected to one lead-out portion 701. The address driver modules U1 to U8 correspond to the upper side address electrode drive circuit 6u of FIG. 1.

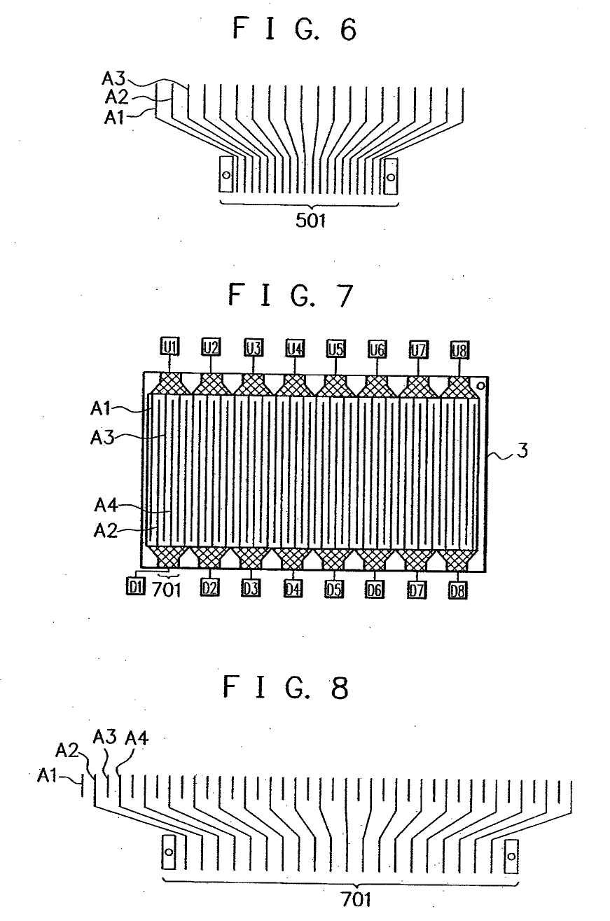

FIG. 8 is an enlarged view of the lead-out portion 701 in the lower end portion of the plasma display panel 3 of FIG. 7. Since the lead-out portion 701 in the lower end portion is connected to only the even numberth address electrodes A2, A4, A6 and so on, intervals of the address electrodes A2, A4, A6 and so on in the lead-out portion 701 can be made comparatively long. Hereby, a short circuit or a break of the address electrodes A2, A4, A6 and so on in the lead-out portion 701 can be prevented when the plasma display device is made highly fine.

However, since the interval of the address electrodes Aj in the plasma display panel 3 is wider compared to the interval of the address electrodes Aj in the lead-out portion 701, there is a possibility that the short circuit or the break occurs at a bent portion in which the interval of the address electrodes Aj changes. A system to solve that problem is a third address electrode system.

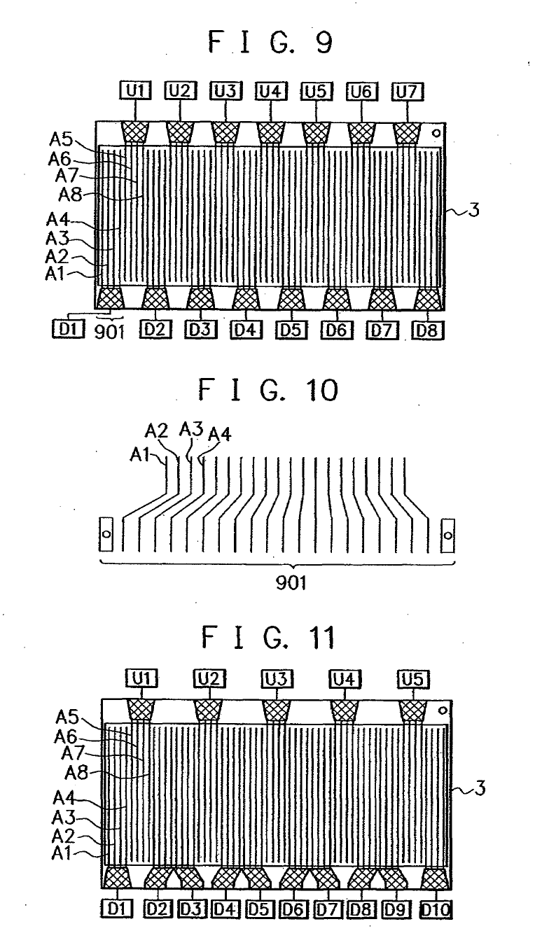

FIG. 9 is a view showing the third address electrode system. The third address electrode system is a system in which an address electrode Aj is led-out from an upper side and a lower side of a plasma display panel 3, similarly to the second address electrode system.

In a lower end portion of the plasma display panel 3, there are provided eight lead-out portions 901 in which, for example, four address electrodes Aj are in one group. The eight lead-out portions 901 are connected to address driver modules D1 to D8. One address driver module is connected to one lead-out portion 901. For example, four address electrodes A1 to A4 are connected to the address driver module D1, while four address electrodes A9 to A12 are connected to the address driver module D2. The address driver modules D1 to D8 correspond to the lower side address electrode drive circuit 6d of FIG. 1.

Also in an upper end portion of the plasma display panel 3, there are provided seven lead-out portions 901 in which, for example, four address electrodes Aj are in one group. The seven lead-out portions 901 are connected to address driver modules U1 to U7 One address driver module is connected to one lead-out portion 901. For example, four address electrodes A5 to A8 are connected to the address driver module U1, while four address electrodes A13 to A16 are connected to the address driver U2. The address driver modules U1 to U7 correspond to the upper side address electrode drive circuit 6u of FIG. 1.

The lower side address driver modules D1 to D8 and the upper side address driver modules U1 to U7 are alternately arranged according to an order of the address electrodes Aj. In other word, the third address electrode system is the system in which the address electrodes Aj are led out to the address driver modules U1, D1 and the like alternately in the upper portion and the lower portion of the plasma display panel 3 according to the order of the address electrodes Aj.

It should be noted that though in FIG. 9 the example of a case is described in which the one lead-out portion 901 is of the group of four address electrodes Aj for the sake of simplifying the drawing, the present invention is not limited thereto. In fact, one lead-out portion 901 is of 384 or 256 address electrodes Aj or the like, the number being different by a specification of an address driver module manufacture. The same thing applies to the case of the second address electrode system (FIG. 7).

A full spec HD (High Definition) plasma display device has a resolution of 1920×1080 pixels. A number of horizontal pixels is 1920. Since one pixel has three colors of red, green and blue, the plasma display panel 3 has 1920×3=5760 address electrodes Aj in total. When one address driver module drives 384 address electrodes Aj, in a case that 5760 address electrodes Aj are to be driven, the address driver modules are efficiently arranged by using fifteen address driver modules.

FIG. 10 is an enlarged view of the lead-out portion 901 in the lower end portion of the plasma display panel 3 of FIG. 9. Since the lead-out portion 901 in the lower end portion is connected to sequential 384 address electrodes Aj, for example, and the address electrodes Aj are led out to the upper side address driver module U1 or the like and to the lower side address driver module D1 or the like, a difference can be made small between the interval of the address electrodes Aj in the plasma display panel 3 and the interval of the address electrodes Aj of the lead-out portion 901. As a result, a bend of the address electrode Aj can be made small so that a short circuit or a break of the address electrode Aj can be prevented.

FIG. 11 is a view showing another third address electrode system. In FIG. 11, an order of leading out address electrodes Aj to address driver modules is different in relation to FIG. 9.

In a lower end portion of a plasma display panel 3, an address driver module D1 is connected to, for example, four address electrodes A1 to A4, an address driver module D2 is connected to, for example, four address electrodes A9 to A12, and an address driver module D3 is connected to, for example, four address electrodes A13 to A16.

In an upper end portion of the plasma display panel 3, an address driver module U1 is connected to, for example, four address electrodes A5 to A8, and an address driver module U2 is connected to, for example, four address electrodes A17 to A20.

It should be noted that though the example is described in which each address driver module is connected to four address electrodes Aj, similarly to the above, in reality each address driver module is connected to 384 address electrodes Aj.

As stated above, in the second and the third address electrode systems, a plurality of the address driver modules U1, D1 and the like are provided in correspondence with a plurality of the groups of the plurality of the address electrodes Aj, in the upper portion and the lower portion of the plasma display panel 3 respectively.

In the second address electrode system of FIG. 7, the address electrodes Aj inconsecutive within the plasma display panel 3 are led out to the respective address driver modules U1, D1 and the like. More specifically, the second address electrode system is the system in which every other address electrodes Aj are led out in the upper portion and the lower portion of the plasma display panel 3 respectively.

The third address electrode systems of FIG. 9 and FIG. 11 are the systems in which the address electrodes Aj consecutive within the plasma display panel 3 are led out to the respective address driver modules U1, D1 and the like.

The third address electrode system of FIG. 9 is the system in which the address electrodes Aj are alternately led out to the address driver modules U1, D1 and the like in the upper portion and the lower portion of the plasma display panel 3 according to the order of the address electrodes Aj.

The third address electrode system of FIG. 11 is the system in which the consecutive address electrodes Aj are led out to the plurality of the address driver modules U1, D1 and the like in the upper portion or the lower portion of the plasma display panel 3.

Hereinafter, there will be described the address electrode system of FIG. 5 as the first address electrode system, the address electrode system of FIG. 7 as the second address electrode system, and the address electrode system of FIG. 9 as the third address electrode system. It is possible that the third address electrode system is applied as the address electrode system of FIG. 11.

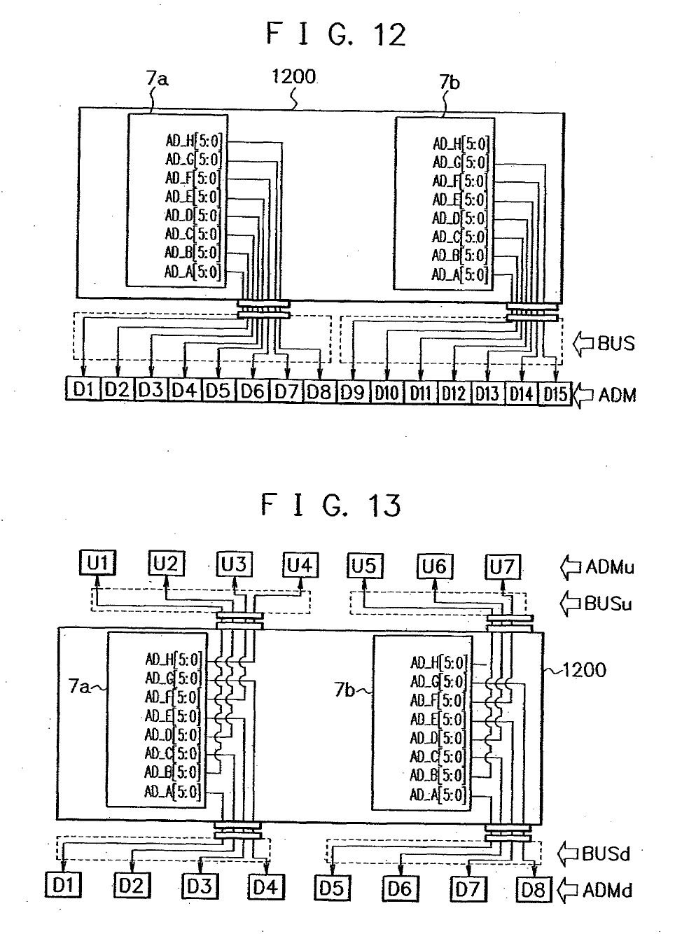

FIG. 12 is a diagram showing a configuration example of control circuits 7a, 7b and an address driver module ADM of the first address electrode system (FIG. 5). The two control circuits 7a and 7b are constituted with two LSI corresponding to the control circuit 7 of FIG. 1, and are provided on a control circuit substrate 1200. The address driver module ADM has lower side address driver modules D1 to D15.

The control circuit 7a has address data output ports AD_A, AD_B, AD_C, AD_D, AD_E, AD_F, AD_G, AD_H, each being 6-bit, and is connected to the address driver modules D1 to D8 via an address bus BUS. The eight address data output ports AD_A to AD_H are connected to the eight address driver modules D1 to D8 respectively.

Similarly, the control circuit 7b has address data output ports AD_A, AD_B, AD_C, AD_D, AD_E, AD_F, AD_G, AD_H, each being 6-bit, and is connected to the address driver modules D9 to D15 via an address bus BUS. The eight address data output ports AD_A to AD_H are connected to the eight address driver modules D9 to D15 respectively.

For example, one address driver module D1 inputs 6-bit address data from the output port AD_A of the control circuit 7a by 384/6=64 times, holds address data of the 386 address electrodes Aj using a shift resister, and applies a voltage to the 384 address electrodes Aj. For example, during the address period Ta of FIG. 4, an address pulse is applied to the address electrode Aj in correspondence with the address data. When selecting a display cell to emit light, the address pulse is applied to the address electrode Aj, and when not selecting the display cell to emit light, the address pulse is not applied to the address electrode Aj. The same thing as in the address driver module D1 applies to the address driver modules D2 to D15.

FIG. 13 is a diagram showing a configuration example of control circuits 7a, 7b and address driver modules ADMu, ADMd of the third address electrode system (FIG. 9). Hereinafter, points in which FIG. 13 differs from FIG. 12 will be described. The upper side address driver module ADMu has upper side address driver modules U1 to U7. The lower side address driver module ADMd has lower side address driver modules D1 to D8.

The control circuit 7a is connected to the upper side address driver modules U1 to U4 via an upper side address bus BUSu and connected to the lower side address driver modules D1 to D4 via a lower side address bus BUSd. The control circuit 7b is connected to the upper side address driver modules U5 to U7 via an upper side address bus BUSu and connected to the lower side address driver modules D5 to D8 via a lower side address bus BUSd.

In the first address electrode system (FIG. 5) all the address electrodes Aj are connected to the lower side address driver modules D1 to D15, while in the third address electrode system (FIG. 9) the address electrodes Aj are alternately connected to the lower side address driver modules D1 to D8 and the upper side address driver modules U1 to U7 Therefore, in the control circuits 7a and 7b, address data output ports AD_A to AD_H are alternately connected to the lower side address driver modules D1 to D8 and the upper side address driver modules U1 to U7. In FIG. 12 and FIG. 13, the numbers of the address driver modules are both fifteen, being the same. Further, in FIG. 12 and FIG. 13, the control circuit 7a and 7b output the same address data.

In the control circuit 7a of FIG. 13, the output port AD_A is connected to the lower side address driver module D1, the output port AD_B is connected to the upper side address driver module U1, the output port AD_C is connected to the lower side address driver module D2, the output port AD_D is connected to the upper side address driver module U2, the output port AD_E is connected to the lower side address driver module D3, the output port AD_F is connected to the upper side address driver module U3, the output port AD_G is connected to the lower side address driver module D4, and the output port AD_H is connected to the upper side address driver module U4.

In the control circuit 7b, the output port AD_A is connected to the lower side address driver module D5, the output port AD_B is connected to the upper side address driver module U5, the output port AD_C is connected to the lower side address driver module D6, the output port AD_D is connected to the upper side address driver module U6, the output port AD_E is connected to the lower side address driver module D7, the output port AD_F is connected to the upper side address driver module U7 and the output port AD_G is connected to the lower side address driver module D8.

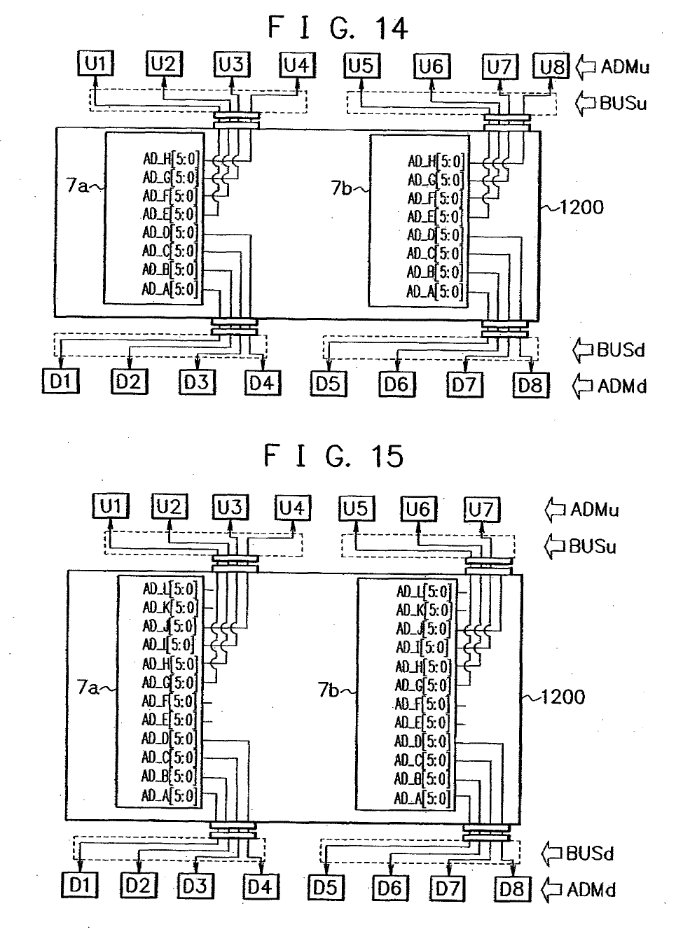

FIG. 14 is a diagram showing a configuration example of control circuits 7a, 7b and address driver modules ADMu, ADMd of the second address electrode system (FIG. 7). Hereinafter, points in which FIG. 14 differs from FIG. 13 will be described. In FIG. 13, seven upper side address driver modules U1 to U7 are included, while in FIG. 14, eight upper side address driver modules U1 to U8 are included. A reason thereof will be described later.

In the control circuit 7a, an output port AD_A is connected to the lower side address driver module D1, an output port AD_B is connected to the lower side address driver module D2, an output port AD_C is connected to the lower side address driver module D3, an output port AD_D is connected to the lower side address driver module D4, an output port AD_E is connected to the upper side address driver module U1, an output port AD_F is connected to the upper side address driver module U2, an output port AD_G is connected to the upper side address driver module U3 and an output port AD_H is connected to the upper side address driver module U4.

In a control circuit 7b, an output port AD_A is connected to the lower side address driver module D5, an output port AD_B is connected to the lower side address driver module D6, an output port AD_C is connected to the lower side address driver module D7, an output port AD_D is connected to the lower side address driver module D8, an output port AD_E is connected to the upper side address diver module U5, an output port AD_F is connected to the upper side address driver module U6, an output port AD_G is connected to the upper side address driver module U7 and an output port AD_H is connected to the upper side address driver module U8.

The second address electrode system (FIG. 7) and the third address electrode system (FIG. 9) are different in correspondence relationship between the address driver module and the address electrode Aj. Thus, in the control circuits 7a and 7b of FIG. 14, display data on one line are rearranged to generate address data, which are outputted from the output ports AD_A to AD_H. That is, the address data outputted by the control circuits 7a and 7b are different in FIG. 13 and FIG. 14. Details thereof will be described later.

Next, there will be described the reason that fifteen address driver modules D1 to D8, U1 to U7 are provided in FIG. 12 and FIG. 13 while sixteen address driver modules D1 to D8, U1 to U8 are provided in FIG. 14.

First, the reason that the number of the address driver modules of FIG. 12 and FIG. 13 is fifteen will be described. As stated above, the number of the horizontal pixel of the full spec HD plasma display device is 1920. Since one pixel has three colors of red, green and blue, the plasma display panel 3 has 1920×3=5760 address electrodes Aj in total. Since one address driver module supplies the voltage to 384 address electrodes Aj, in a case that 5760 address electrodes Aj are to be driven, 5760/384=15 address driver modules are required. If fifteen address driver modules are used, exactly 5760 address electrodes Aj can be driven.

Next, the reason that the number of the address driver modules of FIG. 14 is sixteen will be described. In the second address electrode system (FIG. 7), the address electrodes Aj are alternately connected to the upper side address driver module ADMu and the lower side address driver module ADMd according to the order of the address electrodes Aj. Thus, a number (384×2=768) of the address electrodes corresponding to two address driver modules U1 and D2 becomes one unit. The plasma display panel 3 has 5760 address electrodes Aj in total as described above, and 5760/768=7.5, being indivisible. Thus, for the number of the address driver modules, fifteen is not enough but sixteen is required, leading to a cost increase.

In the third address electrode system, the number of address driver modules can be decreased compared to the second address electrode system, enabling a cost reduction.

With the plasma display device becoming highly fine, it is considered that both the second address electrode system (FIG. 7) and the third address electrode system (FIG. 9) are manufactured. Since a wiring of the control circuit substrate 1200 of the second address electrode system of FIG. 14 and a wiring of the control circuit substrate 1200 of the third address electrode system of FIG. 13 are different, separate pattern designing is required for each of the control circuit substrates 1200. As a result, costs such as a development cost, a purchase cost and a management cost are increased.

In the present embodiment, there are provided a control circuit substrate 1200 and control circuits 7a, 7b which can be used in common for both the second address electrode system (FIG. 7) and the third address electrode system (FIG. 9). Hereinafter, the control circuit substrate 1200 and the control circuits 7a, 7b which can be used in common will be described.

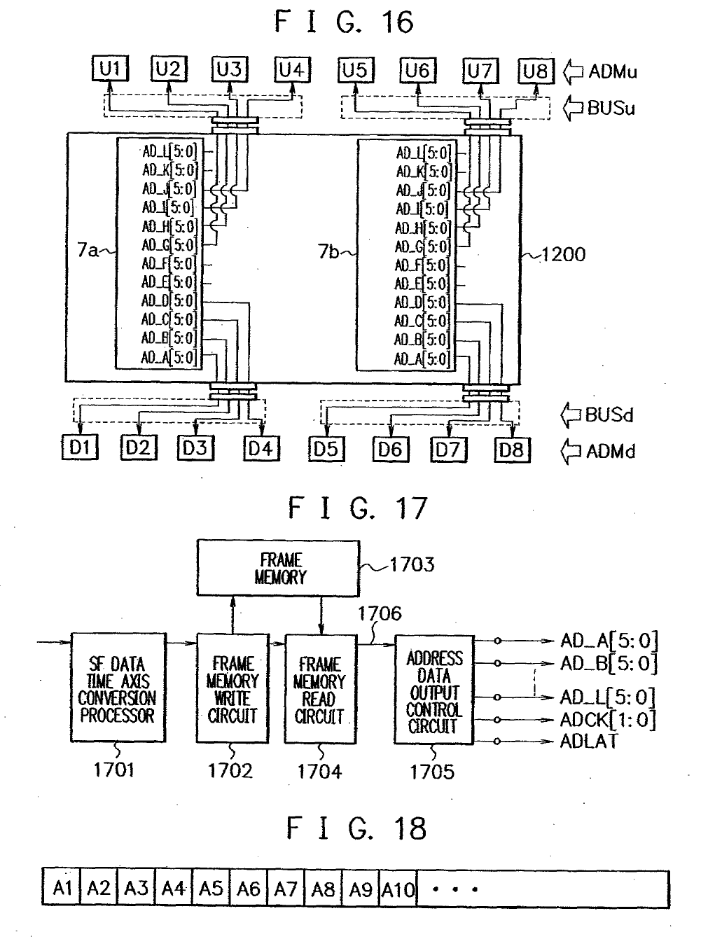

FIG. 15, corresponding to FIG. 13, is a diagram showing a configuration example of the control circuits 7a, 7b and the address driver modules ADMu, ADMd of the third address electrode system (FIG. 9). FIG. 16, corresponding to FIG. 14, is a diagram showing a configuration example of the control circuits 7a, 7b and the address driver modules ADMu, ADMd of the second address electrode system (FIG. 7). Hereinafter, points in which FIG. 15 and FIG. 16 differ from FIG. 13 and FIG. 14 will be described.

In FIG. 15 and FIG. 16, the control circuit substrates 1200 (including wirings) and the control circuits 7a and 7b are the same. The control circuits 7a and 7b have twelve 6-bit address data output ports AD_A to AD_L. In the control circuits 7a and 7b, wirings of the output ports AD_A to AD_D are directed and connected to the lower side address driver module ADMd, while wirings of the output ports AD_G to AD_I are directed and connected to the upper side address driver module ADMu.

In the control circuit 7a, the output ports AD_A to AD_D are respectively connected to the lower side address driver modules D1 to D4, while the output ports AD_G to AD_J are respectively connected to the upper side address driver modules U1 to U4. In the control circuit 7b, the output ports AD_A to AD_D are respectively connected to the lower side address driver modules D5 to D8, while the output ports AD_G to AD_I are respectively connected to the upper side address driver modules U5 to U7.

Next, a difference between the second address electrode system (FIG. 16) and the third address electrode system (FIG. 15) will be described. In the second address electrode system of FIG. 16, the upper side address driver module U8 is connected to the output port AD_J of the control circuit 7b. In contrast, in the third address electrode system of FIG. 15, no address driver module is connected to the output port AD_J of the control circuit 7b. It is because the second address electrode system of FIG. 16 requires sixteen address driver modules D1 to D8, U1 to U8 while the third address electrode system of FIG. 15 requires fifteen address driver modules D1 to D8, U1 to U7.

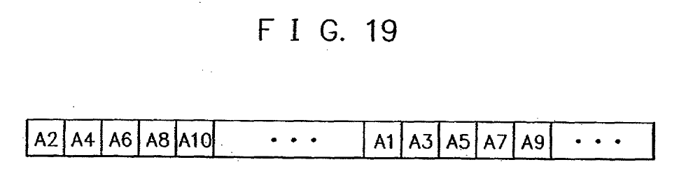

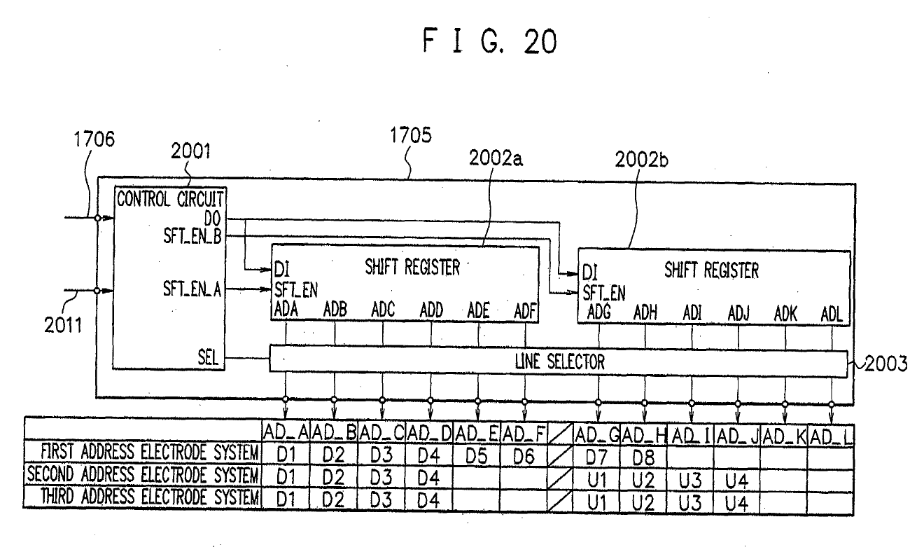

FIG. 17 is a diagram showing a configuration example of the control circuits 7a, 7b of FIG. 15 and FIG. 16. A sub-frame data time axis conversion processor 1701 inputs sub-frame data showing lighting patterns of respective sub-frames of FIG. 3 to perform a time axis conversion processing. The sub-frame data are generated by an image processing circuit. A frame memory write circuit 1702 writes sub-frame data outputted by the sub-frame data time axis conversion processor 1701 to a frame memory 1703. Writing methods are different between the second address electrode system (FIG. 7) and the third address electrode system (FIG. 9). Details thereof will be described later with reference to FIG. 18 and FIG. 19. A frame memory read circuit 1704 reads sub-frame data from the frame memory 1703. An address data output control circuit 1705 inputs the sub-frame data 1706 read by the frame memory read circuit 1704 and outputs the address data to twelve 6-bit address data output ports AD_A to AD_L. Further, the address data output control circuit 1705 outputs signals ADCK and ALDAT. Details of the address data output control circuit 1705 will be described later with reference to FIG. 20.

FIG. 20 is a diagram showing a configuration example of the address data output control circuit 1705 of FIG. 17. A control circuit 2001 inputs the sub-frame data 1706 and address electrode system information 2011. The sub-frame data 1706 are sub-frame data read by the frame memory read circuit 1704 of FIG. 17. The address electrode system information 2011 is information indicating the second address electrode system (FIG. 7) or the third address electrode system (FIG. 9).

A terminal DO of the control circuit 2001 outputs data to terminals D1 of shift registers 2002a and 2002b. Terminals SFT_EN_A and SFT_EN_B of the control circuit 2002 respectively output enable signals to terminals SFT_EN of the shift registers 2002a and 2002b. A terminal SEL of the control circuit 2001 outputs a select signal to a line selector 2003.

The shift register 2002a shifts and latches data inputted to the terminal DI in correspondence with the enable signal inputted to the terminal SFT_EN and outputs address data from six 6-bit address data output terminals ADA to ADF.

The shift register 2002b shifts and latches data inputted to the terminal DI in correspondence with the enable signal inputted to the terminal SFT_EN and outputs address data from six 6-bit address data output terminals ADG to ADL.

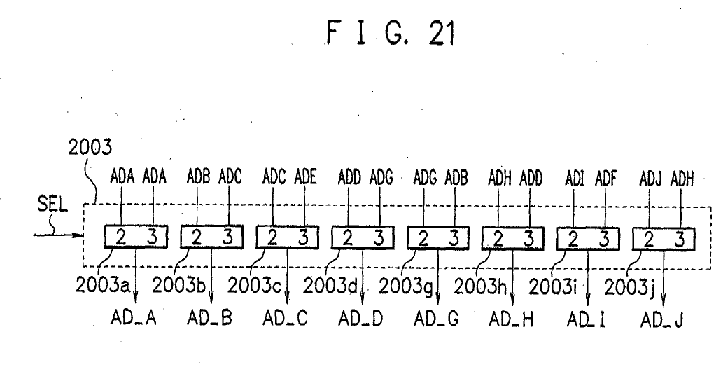

The line selector 2003 switches over connections of twelve output terminals ADA to ADL and twelve output ports AD_A to AD_L in correspondence with the select signal outputted by the terminal SEL of the control circuit 2001. Details thereof will be described later with reference to FIG. 21.

In the first address electrode system (FIG. 5), as shown in FIG. 12, the eight output ports AD_A to AD_H are respectively connected to the address driver modules D1 to D8.

In the second address electrode system (FIG. 7), as shown in FIG. 16, the four output ports AD_A to AD_D are respectively connected to the lower side address driver modules D1 to D4 while the four output ports AD_G to AD_J are respectively connected to the upper side address driver modules U1 to U4.

In the third address electrode system (FIG. 9), as shown in FIG. 15, the four output ports AD_A to AD_D are respectively connected to the lower side address driver modules D1 to D4 while the four output ports AD_G to AD_J are respectively connected to the upper side address driver modules U1 to U4, similarly to the second address electrode system (FIG. 7).

FIG. 21 is a diagram showing a configuration example of the line selector 2003 of FIG. 20. In a case of the second address electrode system, the line selector 2003 connects the output terminals ADA to ADJ and the output ports AD_A to AD_J in straight such that the connection becomes that of FIG. 16 from that of FIG. 14. On the other hand, in a case of the third address electrode system, the line selector 2003 connects the output terminals ADA to ADJ and output ports AD_A to AD_J such that the connection becomes that of FIG. 15 from that of FIG. 13.

The selector 2003a outputs address data of the output terminal ADA to the output port AD_A in either case that the select signal of the terminal SEL indicates the second or third address electrode system.

The selector 2003b selects address data of the output terminal ADB when the select signal of the terminal SEL indicates the second address electrode system and selects address data of the output terminal ADC when the select signal of the terminal SEL indicates the third address electrode system, and then outputs the data to the output port AD_B.

The selector 2003c selects address data of the output terminal ADC when the select signal of the terminal SEL indicates the second address electrode system and selects address data of the output terminal ADE when the select signal of the terminal SEL indicates the third address electrode system, and then outputs the data to the output port AD_C.

The selector 2003d selects address data of the output terminal ADD when the select signal of the terminal SEL indicates the second address electrode system and selects address data of the output terminal ADG when the select signal of the terminal SEL indicates the third address electrode system, and then outputs the data to the output port AD_D.

The selector 2003g selects address data of the output terminal ADG when the select signal of the terminal SEL indicates the second address electrode system and selects address data of the output terminal ADB when the select signal of the terminal SEL indicates the third address electrode system, and then outputs the data to the output port AD_G.

The selector 2003h selects address data of the output terminal ADH when the select signal of the terminal SEL indicates the second address electrode system and selects address data of the output terminal ADD when the select signal of the terminal SEL indicates the third address electrode system, and then outputs the data to the output port AD_H.

The selector 2003i selects address data of the output terminal ADI when the select signal of the terminal SEL indicates the second address electrode system and selects address data of the output terminal ADF when the select signal of the terminal SEL indicates the third address electrode system, and then outputs the data to the output port AD_I.

The selector 2003j selects address data of the output terminal ADJ when the select signal of the terminal SEL indicates the second address electrode system and selects address data of the output terminal ADH when the select signal of the terminal SEL indicates the third address electrode system, and then outputs the data to the output port AD_J.

FIG. 18 is a diagram showing sub-frame data which the frame memory write circuit 1702 writes to the frame memory 1703 in the third address electrode system (FIG. 9) The frame memory write circuit 1702 writes data to the frame memory 1703 on a line basis according to the order of the address electrodes Aj. The frame memory read circuit 1704 reads data from the frame memory 1703 in correspondence with the order of the address electrodes and the order of address driver modules of FIG. 9.

FIG. 19 is a diagram showing sub-frame data which the frame memory write circuit 1702 writes to the frame memory 1703 in the second address electrode system (FIG. 7). The frame memory write circuit 1702 writes data to the frame memory 1703 on a line basis such that first the data of even numberth address electrodes A2, A4, and so on are arranged and subsequently the data of odd numberth address electrodes A1, A3, and so on are arranged. The frame memory read circuit 1704 reads data from the frame memory 1703 in correspondence with the order of the address electrodes and the order of the address driver modules of FIG. 7.

As stated above, in correspondence with the second and third address electrode systems, the display data (sub-frame data) on one line are rearranged to generate address data and the output ports of the address data are switched over, whereby the control circuit substrate 1200 (including wirings) and the control circuits 7a, 7b can be used in common for the second and third address electrode systems.

The line selector 2003 performs the above-described switch over in correspondence with the system for leading out the address electrodes Aj from the plasma display panel 3 to the address driver module. The control circuit substrate 1200 and the control circuits 7a, 7b can be used in common for a plurality of systems for leading out the address electrodes Aj from the plasma display panel 3. Since it is unnecessary to manufacture a separate control circuit substrate and a control circuit for each of the plural systems, a reduction of costs such as a development cost, a purchase cost and a management cost for control circuits can be realized.

A control circuit of a plasma display panel can be provided, the control circuit being able to be used in common in a plurality of systems for leading out address electrodes from the plasma display panel. Since it is unnecessary to manufacture a separate control circuit for each of the plural systems, a reduction of costs such as a development cost, a purchase cost and a management cost for control circuits can be realized.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display device comprising:
a plasma display panel having a plurality of address electrodes selecting a display cell to emit light;
a data generation circuit generating and outputting a plurality of address data for an application of a voltage to the plurality of address electrodes;
a plurality of output ports outputting the plurality of address data; and
a selector switching over connections of outputs of the plurality of address data generated by said data generation circuit and said plurality of output ports.

2. The plasma display device according to claim 1, wherein said selector performs the switch over in correspondence with a select signal.

3. The plasma display device according to claim 1, wherein said selector performs the switch over in correspondence with a system of leading out the address electrodes from said plasma display panel to an address electrode drive circuit.

4. The plasma display device according to claim 3,
wherein a plurality of the address electrode drive circuits are provided in correspondence with a plurality of groups of the plurality of address electrodes in an upper portion and a lower portion of said plasma display panel respectively, and
wherein said selector performs the switch over in correspondence with a first system in which the address electrodes inconsecutive within said plasma display panel are led out to the respective address electrode drive circuits and a second system in which the address electrodes consecutive within said plasma display panel are led out to the respective address electrode drive circuits.

5. The plasma display device according to claim 4, wherein the first system is a system in which the every other address electrodes are led out in the upper portion and the lower portion of said plasma display panel respectively.

6. The plasma display device according to claim 4, wherein the second system is a system in which the address electrodes are alternately led out to the address electrode drive circuits in the upper portion and the lower portion of said plasma display panel according to an order of the address electrodes.

7. The plasma display device according to claim 4, wherein the second system is a system in which the consecutive address electrodes are led out to the plurality of the address electrode drive circuits in the upper portion or the lower portion of said plasma display panel.

8. The plasma display device according to claim 4, wherein said data generation circuit generates the address data by rearranging display data on one line in correspondence with the first system and the second system.

9. The plasma display device according to claim 3, wherein said selector performs the switch over in correspondence with a first system in which the every other address electrodes are led out to the address electrode drive circuits in an upper portion and a lower portion of said plasma display panel respectively and a second system in which the plurality of consecutive address electrodes are led out to the address electrode drive circuits in the upper portion and the lower portion of said plasma display panel respectively.

10. A plasma display device comprising:
a plasma display panel having a plurality of address electrodes selecting a display cell to emit light;
a data generation circuit generating and outputting a plurality of address data for an application of a voltage to the plurality of address electrodes; and
a plurality of output ports outputting the plurality of address data,
wherein said data generation circuit generates the address data by rearranging display data on one line in correspondence with a system of leading out the address electrodes from said plasma display panel to an address electrode drive circuit.
